(19) United States
(12) Patent Application Publication
(10) Pub. No.: US 2024/0013438 A1
(43) Pub. Date: Jan. 11, 2024

(54) METHOD FOR AUTOMATICALLY RECOGNIZING CORRESPONDENCE BETWEEN CALIBRATION PATTERN FEATURE POINTS IN CAMERA CALIBRATION

(71) Applicant: ELECTRONICS AND TELECOMMUNICATIONS RESEARCH INSTITUTE, Daejeon (KR)

(72) Inventors: Hyun KANG, Daejeon (KR); Jae-Hean KIM, Sejong-si (KR); Bon-Ki KOO, Daejeon (KR)

(73) Assignee: ELECTRONICS AND TELECOMMUNICATIONS RESEARCH INSTITUTE, Daejeon (KR)

(21) Appl. No.: 18/346,508

(22) Filed: Jul. 3, 2023

(30) Foreign Application Priority Data
Jul. 11, 2022 (KR) 10-2022-0084960
Oct. 6, 2022 (KR) 10-2022-0127954

(51) Int. Cl. G06T 7/80

(52) U.S. Cl. CPC G06T 7/80

(57) ABSTRACT

Disclosed herein is a method for automatically recognizing correspondence between calibration pattern feature points in camera calibration. The method for automatically recognizing correspondence between calibration pattern feature points in camera calibration includes generating calibration pattern candidates from an input image using a point-line-face-multi-face hierarchical structure, and performing verification on the calibration pattern candidates based on a preset verification condition.

### CROSS REFERENCE TO RELATED APPLICATIONS

This application claims the benefit of Korean Patent Application Nos. 10-2022-0084960, filed Jul. 11, 2022 and 10-2022-0127954, filed Oct. 6, 2022, which are hereby incorporated by reference in their entireties into this application.

### BACKGROUND OF THE INVENTION

### 1. Technical Field

The present disclosure relates generally to technology for automatically acquiring calibration pattern feature point information when cameras are calibrated in an outside-in-type three-dimensional (3D) scan system that is a system in which multiple cameras scan a subject while rotating around the subject with the subject being located at the center so as to perform 3D digital restoration.

### 2. Description of the Related Art

In a camera calibration process essential for 3D image processing, a correspondence problem is necessary for automation of a camera calibration system. The method that was manually performed in the past has been developed such that more various problems can be solved by various researchers.

The correspondence problem may represents a matching relationship between 3D-2D points to be inserted into a calibration algorithm, and may be process of determining which points match each other among points on a known calibration pattern (3D pattern or 2D plane pattern) and points on an image obtained by capturing the calibration pattern.

In conventional technology, an Aruco marker similar to a two-dimensional (2D) barcode has been assigned to a normal feature point, and then the location of the feature point in the image has been determined. This is advantageous in an automated multi-camera production, but it is disadvantageous in that an area in which pattern feature points can be arranged is likely to be lost. Further, because high resolution is required in order to recognize a specific marker, a problem arises in that calibratable resolution is reduced.

Further, in conventional technology, the center of the feature points of a pattern is estimated using a checkerboard, and markers called Exterior Orientation Parameters (EOP) are used to automatically detect the sequence of the feature points. However, there is a problem in that 50% or more of the entire checkerboard cannot be used for the feature points of the pattern.

Furthermore, in the conventional technology, in order to automatically recognize a checkerboard, specific markers are arranged in a white area, but the requirement for the resolution of a captured image depends on the recognition of the specific markers rather than on the recognition of a calibration pattern, thus causing a problem in which calibratable resolution is reduced.

Furthermore, in conventional research, a region growing strategy has been used. Dud to the characteristics of a checkerboard, edge lines in two directions are present on found feature points. An ordered pair of feature points in which an energy function is minimized is obtained by collecting feature points encountered while traveling in those directions. Although this method is evaluated as a stable method to such an extent that many applications/modifications are made in subsequent research, the sequence of feature points in each pattern can be checked, but the sequence of patterns cannot be known, whereby a problem may arise in that user input or a marker for automatic recognition needs to be used.

### SUMMARY OF THE INVENTION

Accordingly, the present disclosure has been made keeping in mind the above problems occurring in the prior art, and an object of the present disclosure is to provide a method for automatically recognizing a correspondence between calibration pattern feature points in camera calibration that automatically recognizes numbers assigned to pattern feature points in an image in order to perform automated calibration of a camera and a sensor that are used in a 3D scanner.

In accordance with an aspect of the present disclosure to accomplish the above object, there is provided a method for automatically recognizing correspondence between calibration pattern feature points in camera calibration includes generating calibration pattern candidates from an input image using a point-line-face-multi-face hierarchical structure, and performing verification on the calibration pattern candidates based on a preset verification condition.

### BRIEF DESCRIPTION OF THE DRAWINGS

The above and other objects, features and advantages of the present disclosure will be more clearly understood from the following detailed description taken in conjunction with the accompanying drawings, in which:

FIG. 1 is a flowchart illustrating a method for automatically recognizing a correspondence between calibration pattern feature points in camera calibration according to an embodiment;

FIG. 2 is a diagram illustrating an example of an image captured by a camera;

FIG. 3 is a diagram illustrating the state in which feature points are detected in an image according to an embodiment;

FIG. 4 is a diagram illustrating the state in which lines are detected in an image according to an embodiment;

FIG. 5 is a diagram illustrating the state in which a face is detected in an image according to an embodiment;

FIG. 6 is a diagram illustrating the state in which multiple faces are detected in an image according to an embodiment;

FIG. 7 is a diagram illustrating examples of planes that can be formed using pairs of 5-point lines when n=5;

FIG. 8 is a development view of a polyhedron in the case of n=5; and

FIG. 9 is a block diagram illustrating the configuration of a computer system according to an embodiment.

### DESCRIPTION OF THE PREFERRED EMBODIMENTS

Advantages and features of the present disclosure and methods for achieving the same will be clarified with reference to embodiments described later in detail together with the accompanying drawings. However, the present disclosure is capable of being implemented in various forms, and is not limited to the embodiments described later, and these embodiments are provided so that this disclosure will be thorough and complete and will fully convey the scope of the present disclosure to those skilled in the art. The present disclosure should be defined by the scope of the accompanying claims. The same reference numerals are used to designate the same components throughout the specification.

It will be understood that, although the terms “first” and “second” may be used herein to describe various components, these components are not limited by these terms. These terms are only used to distinguish one component from another component. Therefore, it will be apparent that a first component, which will be described below, may alternatively be a second component without departing from the technical spirit of the present disclosure.

The terms used in the present specification are merely used to describe embodiments, and are not intended to limit the present disclosure. In the present specification, a singular expression includes the plural sense unless a description to the contrary is specifically made in context. It should be understood that the term “comprises” or “comprising” used in the specification implies that a described component or step is not intended to exclude the possibility that one or more other components or steps will be present or added.

Unless differently defined, all terms used in the present specification can be construed as having the same meanings as terms generally understood by those skilled in the art to which the present disclosure pertains. Further, terms defined in generally used dictionaries are not to be interpreted as having ideal or excessively formal meanings unless they are definitely defined in the present specification.

In the present specification, each of phrases such as “A or B”, “at least one of A and B”, “at least one of A or B”, “A, B, or C”, “at least one of A, B, and C”, and “at least one of A, B, or C” may include any one of the items enumerated together in the corresponding phrase, among the phrases, or all possible combinations thereof.

Embodiments of the present disclosure will now be described in detail with reference to the accompanying drawings. Like numerals refer to like elements throughout, and overlapping descriptions will be omitted.

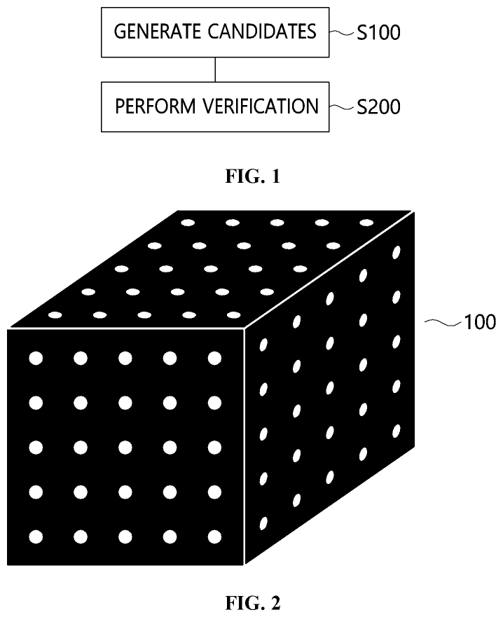

FIG. 1 is a flowchart illustrating a method for automatically recognizing a correspondence between calibration pattern feature points in camera calibration according to an embodiment.

Referring to FIG. 1, the method for automatically recognizing a correspondence between calibration pattern feature points in camera calibration according to the embodiment may include step S100 of generating calibration pattern candidates and step S200 of performing verification on the calibration pattern candidates.

At step S100 of generating the calibration pattern candidates, the calibration pattern candidates may be generated using a point-line-face-multi-face hierarchical structure in an input image. At step S200 of performing verification, verification may be performed on the calibration pattern candidates based on preset verification conditions.

Hereinafter, a detailed process of automatically recognizing a correspondence between calibration pattern feature points in camera calibration will be described with reference to FIGS. 2 to 8.

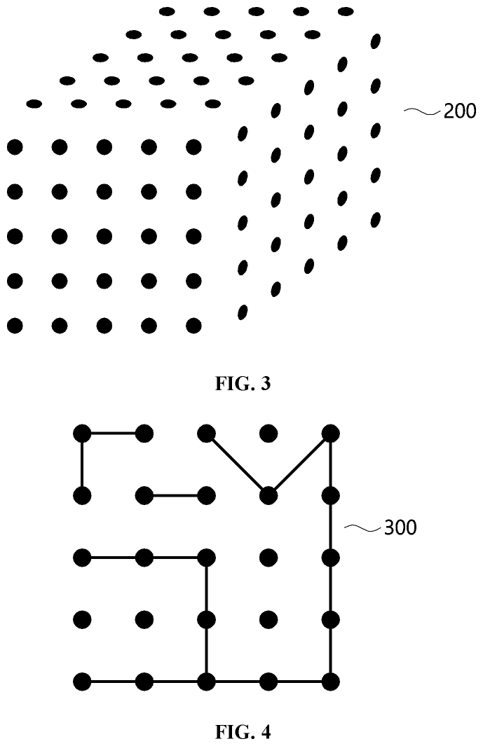

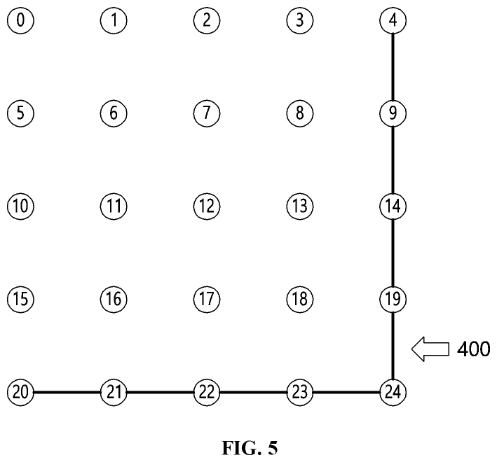

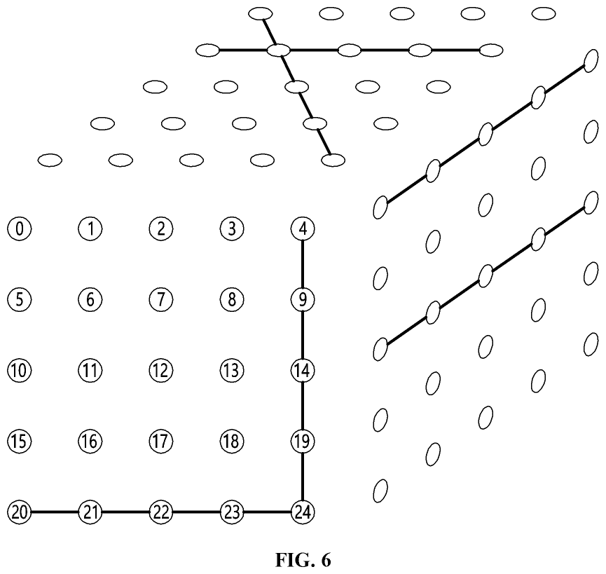

FIG. 2 is a diagram illustrating an example of an image captured by a camera, FIG. 3 is a diagram illustrating the state in which feature points are detected in an image according to an embodiment, FIG. 4 is a diagram illustrating the state in which lines are detected in an image according to an embodiment, FIG. 5 is a diagram illustrating the state in which a face is detected in an image according to an embodiment, and FIG. 6 is a diagram illustrating the state in which multiple faces are detected in an image according to an embodiment.

In an embodiment of the present disclosure, a hierarchical structure and a candidate verification method may be used as a method for automatic recognition. An object to be solved in the embodiment of the present disclosure relates to calibration of a camera (or a camera-sensor) system which intends to perform 3D restoration (e.g., digital 3D data acquisition, 3D scanning, or the like) by capturing a subject using a camera while rotating the camera around the subject, with the subject being located at the center. In order to calibrate various types of information of the rotating camera and sensor, a 3D calibration pattern is required, and automatic processing of the pattern plays an important role in productivity and maintenance.

In an image 100 according to an embodiment, as illustrated in FIG. 2, a 3D pattern structure is set to a polyhedron. Each face is implemented as a 2D plane pattern of typical camera calibration. Therefore, it is assumed that the entire structure is implemented as a hierarchical structure of points, lines, a face, and multiple faces (i.e., a point-line-face-multi-face hierarchical structure).

As shown in FIG. 3, the most basic element is one point 200. Because points cannot be physically represented, they are represented by a checkerboard, an ellipse, a concentric circle, or the like, to analyze the characteristics thereof, whereby the locations of the points are determined.

As illustrated in FIG. 4, a line 300 is defined as a finite set of points. In the case of a plane pattern used in camera calibration, pattern points are represented by preset numbers as in the case of a width of 4 and a length of 3, wherein the width of 4 and the length of 3 used here denote the numbers of points forming the line. In other words, the line may have a maximum number of points, which are more than 2.

As illustrated in FIG. 5, a face 400 may be defined as a finite set of lines. The maximum number of sets may be defined when a 3D pattern structure is configured. Similar to the definition of lines, faces may have a maximum number of lines, which are more than 2.

As illustrated in FIG. 6, a multi-face structure, which is the last structure, is a final structure forming a 3D pattern structure. The object to be solved in the present disclosure is an environment in which a camera captures an image of a subject located at the center while rotating around the subject. As a polyhedron closer to a sphere is formed, an area vertically meeting the camera is increased, and thus a distortion phenomenon attributable to light or material may be reduced. However, difficulty in production is increased that much. Therefore, the polyhedron may have a finite number of faces.

In an embodiment of the present disclosure, image processing for automatic recognition may be a process of analyzing a certain point (2D coordinates) on a captured 2D image plane and determining a point, a line, and a face of a 3D pattern which the certain point of the 2D image plane corresponds to. For this method, hierarchical structure and candidate-verification methodology may be used.

First, candidates that are likely to be calibration pattern points in the image are generated based on points. Regardless of whether the image is represented by a checkerboard pattern, an elliptical structure, or a concentric structure, the calibration pattern points may be designed to have respective clear features unlike other noise in the image.

The checkerboard pattern widely used in camera calibration may obtain two intersecting straight lines using simple image integral values by alternately arranging four rectangles having a large light intensity difference, and may find an intersecting point between the intersecting straight lines as a pattern point.

Even in the case of an elliptical structure, ellipses having a large contrast ratio are designed using pattern points, whereby a center point may be estimated using only simple image processing (e.g., Canny operation).

The concentric structure may be a structure in which an ellipse is placed in another ellipse, and inner/outer ellipses are found through a Canny operation, and calibration points may be specified based on whether the inner/outer ellipses have the same center and based on geometric characteristics of intersecting points between a straight line passing through the center and the inner/outer ellipses. Such a concentric structure has been conventionally executed in a lot of calibration research, with the result that excellent achievements may be obtained.

In an embodiment of the present disclosure, all candidates that can be observed in lower layers while moving from bottom to top in a hierarchical structure are generated, and are verified using constraints that enable the candidates to be checked on an upper layer, and thus suitable candidates are selected. Through the use of the points specified using an existing method (hereinafter referred to as “feature points”), lines are found based on the hierarchical structure according to the present disclosure. Through a non-hidden primary connection between the feature points and other feature points, basic candidate 2-point lines may be generated.

Connections between the basic candidate 2-point lines and another basic candidate 2-point line having a point shared with them are extended. A candidate 3-point line on which two points are not to be shared and only one point is shared among the 2-point lines is generated. In this way, a connection from all candidate 3(=k)-point lines to a next k+1-point line is attempted. When attempting to connect point lines, the k-point line needs to have a single shared point with the corresponding basic candidate 2-point line. When k-extension reaches a finally predefined n-point line, the generation of candidates for lines may be stopped.

A verification step may be performed on such line candidates. The candidate k-point lines ranging from 2-point lines to the n-point lines have various verification characteristics.

A first verification characteristic is linearity, and indicates that individual points in each k-point line need to theoretically form an angle of 180 degrees with neighboring points. Due to the characteristics of an image before being calibrated, the image has more curved lines than straight lines. Further, because a low-distortion lens is utilized due to the camera characteristics of the system which captures an image of a subject with the subject being placed at the center, θ in 180±θ has a small value and is experimentally determined in system design.

A second verification characteristic is to determine whether an abnormal connection is made. All k-point lines need to form a single line in themselves. Therefore, a connection line between points is not to intersect an additional connection line between other points.

A third verification characteristic is a cross ratio. Such a cross ratio may be applied to 3-point lines or more-point lines. In the case of a 3-point line, the ratio of the distances between four points including an infinite point and the three points of the 3-point line is obtained, and in the case of a 4-point line, the ratio of the distances between four points themselves in the 4-point line is obtained. According to the experiments, the verification rate of those point-lines was not good as expected. In an embodiment, a point structure is completed using only n-point line candidates and verification.

A face is found from the n-point lines by again using a hierarchical structure and a candidate-verification method. A plane pattern used in the present disclosure has the characteristics of horizontal-vertical lines. A diagonal line may also be used, but it is used only for an exceptional condition due to difficulty in experimental verification. In a plane pattern having a horizontal length of c and a vertical length of r, c*r+c*(c−1)+r*(r−1)+c+r+1 possible faces are generated with two n-point lines. For simplicity of the problem, the present disclosure sets c=r=n.

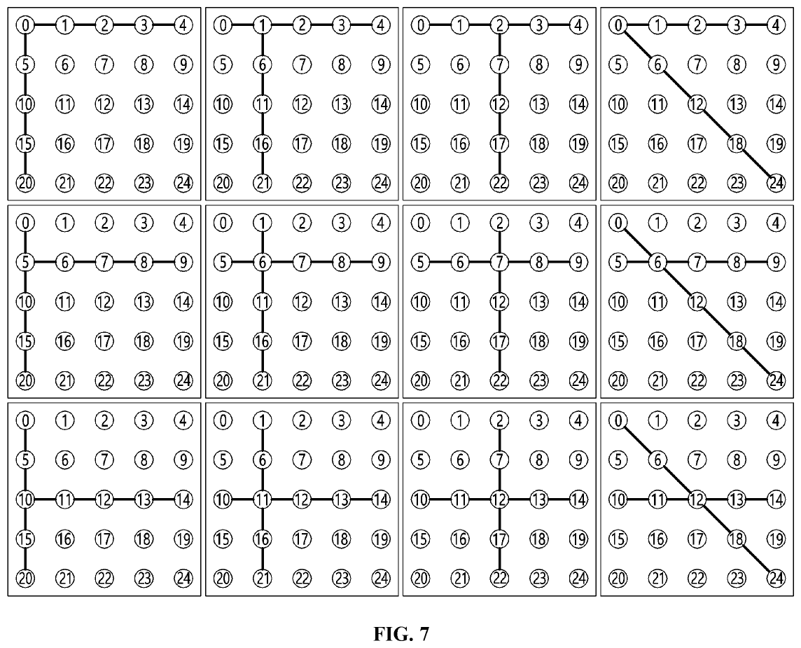

FIG. 7 is a diagram illustrating examples of planes that can be generated using a pair of 5-point lines when n=5.

In FIG. 7, 12 possible planes that can be generated are illustrated. The two n-point lines (e.g., 5 in the case of the examples) have only information about the number of intersecting points between mutual n-point lines and about one of the five points at which the n-point lines meet. Further, because those planes are mirror images, the locations of possible intersecting points are only locations 0, 1, and 2 when n=5. The points at locations 3 and 4 are logically identical to points at locations 0 and 1 when the corresponding image is left-right reversed. In the image, when the location of a calibration pattern cannot be limited, and the target to be applied is an outside-in scanner, a portion observed from the front and a portion observed from the rear are opposite each other. Therefore, planes generated from 2-point lines are limited.

Depending on the number and the locations of intersecting points, the sequential location of each point through which the corresponding line passes on the actual plane needs to be detected. This is obtained by estimating whether each 5-point line is a horizontal line, a vertical line or a diagonal line on the plane and substituting the 5-point line into the plane. In FIG. 7, these examples thereof may be observed.

An upper-left portion indicates the case where two n-point lines horizontally-vertically intersect each other, an upper-right portion indicates the case where two n-point lines horizontally-horizontally intersect each other, a lower-left portion indicates the case where two n-point lines vertically-diagonally intersect each other, and a lower-right portion indicates the case where two n-point lines horizontally-diagonally intersect each other. The numbers of respective cases that may appear are defined such that, in the case of n=5 in the embodiment, the number of horizontal-vertical intersection cases is 5×5, the number of horizontal-horizontal intersection cases is 5×4, the number of vertical-vertical intersection cases is 5×4, the number of vertical-diagonal intersection cases is 5, the number of horizontal-diagonal intersection cases is 5, and the number of diagonal-diagonal intersection cases is 1. For each of the cases, one face candidate may be generated.

In order to generate face candidates, the cases where the number of intersecting points is 0 and whether the number of intersecting points is 1 may be taken into consideration for two n-point (straight) lines. The cases where the number of intersecting points is two or more are regarded as unsuitable faces and then excluded. The cases where the number of intersecting points is 0 correspond to the cases of horizontal-horizontal intersection and vertical-vertical intersection, and the cases where the number of intersecting points is 1 correspond only to the case of horizontal-vertical intersection, the case of horizontal-diagonal intersection, the case of vertical-diagonal intersection, and the case of diagonal-diagonal intersection. Considering an embodiment of n=5 for detailed description, one intersecting point is limited only to a specific case depending on the location of the intersecting point. The cases where intersecting points are both endpoints are limited to points at location numbers 0, 4, 20, and 24, as illustrated in the upper-left portion of FIG. 7. The cases where the intersecting points are located at the second positions from the endpoints are limited only to points at location numbers 6, 8, 16, and 18, whereby limited cases may be represented in such a form.

These face candidates undergo verification in the concept of faces. Because each face includes multiple k-point lines and multiple points, conditions in which a face including a largest number of k-point lines and a largest number of points can be selected is assigned. The verification conditions for candidate verification are given as follows.

Face condition (plane condition) 1-homography condition: two straight lines have 2n or 2n−1 points and the corresponding face has n×n points. When homography is obtained from four points among 2n points, other n×n points present on the same plane may be estimated. By means of the maximum number of matching cases between the n×n points and the other n×n points and the shortest distance between the matching points, a scores between matching points may be calculated using the following Equation (1):

d=αN(i,j)+ [symbol] D(i,j) (1)

Here, i is the plane of the n×n points obtained through homography and j is the plane designed through pattern points. N(i, j) denotes the number of matching points between the two planes, and D(i, j) denotes the distance between two matching points, and corresponds to a unitless ratio value known as “scale-up-to”. α and β are experimentally obtained weights.

Face condition (plane condition) 2—clockwise directionality: sequence numbers in which two straight lines match each other need to have clockwise directionality. Each n-point line has a specific sequence number in the corresponding pattern, and sequence numbers formed by two straight lines are set to have clockwise directionality so as to remove meaningless pairs of two straight lines.

When combination candidates of two straight lines forming the face pass verification through the face conditions, candidate faces are generated. The candidate faces have intra-plane characteristics, which have been verified through respective verification conditions. These candidate faces are verified through the inter-plane conditions of a 3D pattern. The inter-plane condition is given as follows.

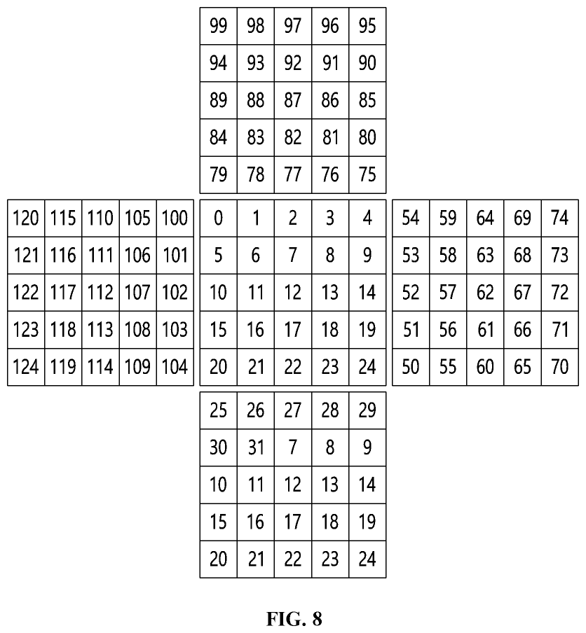

FIG. 8 is a development view of a polyhedron in the case of n=5.

As illustrated in FIG. 8, there is inter-plane condition 1, wherein points in neighboring faces have face numbers that cannot be close to each other. In the embodiment of n=5, number 0 needs to be close to numbers 100 and 79, but cannot be close to 104, 120, 124, 75, 95, and 99. Based on this structural condition, face candidates meeting the condition are removed.

Inter-plane condition 2: when a camera intrinsic parameter is approximated, an image projection process may be estimated using only feature points on a face (plane). A 3D pattern may be re-projected onto the current image based on camera extrinsic parameters R and T that are approximately estimated through the process, whereby the inter-plane relationship may be specified. In this case, there is a need to determine even whether the points are hidden by other points, and this determination may be performed depending on whether the endpoints of pattern points are located in the clockwise direction of the projected points. This is the same principle based on which front and rear portions are identified by determining the directionality of endpoints forming a certain face in a 3D structure.

The above-described method for automatically recognizing correspondence between calibration pattern feature points in camera calibration may be performed by an apparatus for automatically recognizing correspondence between calibration pattern feature points in camera calibration.

The apparatus for automatically recognizing correspondence between calibration pattern feature points in camera calibration according to an embodiment may be implemented in a computer system such as a computer-readable storage medium.

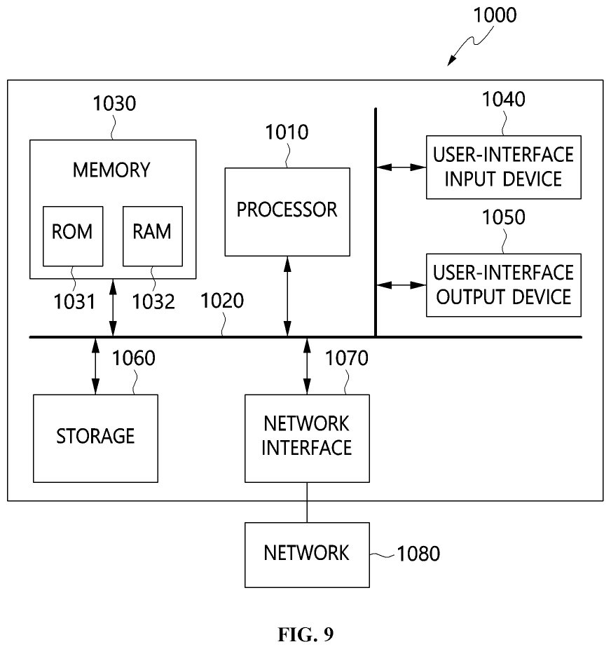

FIG. 9 is a diagram illustrating the configuration of a computer system according to an embodiment.

Referring to FIG. 9, a computer system 1000 may include one or more processors 1010, memory 1030, a user interface input device 1040, a user interface output device 1050, and storage 1060, which communicate with each other through a bus 1020. The computer system 1000 may further include a network interface 1070 connected to a network 1080.

Each processor 1010 may be a Central Processing Unit (CPU) or a semiconductor device for executing programs or processing instructions stored in the memory 1030 or the storage 1060. The processor 1010 may be a kind of CPU, and may control the overall operation of the apparatus for automatically recognizing correspondence between calibration pattern feature points in camera calibration.

The processor 1010 may include all types of devices capable of processing data. The term processor as herein used may refer to a data-processing device embedded in hardware having circuits physically constructed to perform a function represented in, for example, code or instructions included in the program. The data-processing device embedded in hardware may include, for example, a microprocessor, a CPU, a processor core, a multiprocessor, an application-specific integrated circuit (ASIC), a field-programmable gate array (FPGA), etc., without being limited thereto.

The memory 1030 may store various types of data for the overall operation such as a control program for performing a method for automatically recognizing correspondence between calibration pattern feature points in camera calibration according to an embodiment. In detail, the memory 1030 may store multiple applications executed by the apparatus for automatically recognizing correspondence between calibration pattern feature points in camera calibration, and data and instructions for the operation of the apparatus for automatically recognizing correspondence between calibration pattern feature points in camera calibration.

Each of the memory 1030 and the storage 1060 may be a storage medium including at least one of a volatile medium, a nonvolatile medium, a removable medium, a non-removable medium, a communication medium, an information delivery medium or a combination thereof. For example, the memory 1030 may include Read-Only Memory (ROM) 1031 or Random Access Memory (RAM) 1032.

The particular implementations shown and described herein are illustrative examples of the present disclosure and are not intended to limit the scope of the present disclosure in any way. For the sake of brevity, conventional electronics, control systems, software development, and other functional aspects of the systems may not be described in detail. Furthermore, the connecting lines or connectors shown in the various presented figures are intended to represent exemplary functional relationships and/or physical or logical couplings between the various elements. It should be noted that many alternative or additional functional relationships, physical connections, or logical connections may be present in an actual device. Moreover, no item or component may be essential to the practice of the present disclosure unless the element is specifically described as “essential” or “critical”.

The embodiment may automatically recognize the feature points of respective faces and relationships between faces without requiring certain additional recognition markers in an existing calibration pattern. This may be applied to various resolutions, and in particular, accurate calibration may be conducted in a system which performs 3D restoration through cameras rotating around a subject with the subject located at the center.

Therefore, the spirit of the present disclosure should not be limitedly defined by the above-described embodiments, and it is appreciated that all ranges of the accompanying claims and equivalents thereof belong to the scope of the spirit of the present disclosure.

What is claimed is:

1. A method for automatically recognizing correspondence between calibration pattern feature points in camera calibration, comprising:
generating calibration pattern candidates from an input image using a point-line-face-multi-face hierarchical structure; and
performing verification on the calibration pattern candidates based on a preset verification condition.

2. The method of claim 1, wherein the input image is an image acquired by capturing a subject while moving around the subject.

3. The method of claim 2, wherein the input image is represented by at least one of a checkerboard, an ellipse, and a concentric circle or a combination thereof, and a location of each point is determined by analyzing a characteristic of at least one of the checkerboard, the ellipse, and the concentric circle or a combination thereof.

4. The method of claim 1, wherein each line is generated using a preset number of points.

5. The method of claim 1, wherein each face is determined based on finite sets of lines, and a maximum number of finite sets of lines is determined when a three-dimensional (3D) structure is configured.

6. An apparatus for automatically recognizing correspondence between calibration pattern feature points in camera calibration, comprising:
a memory configured to store a control program for automatically recognizing correspondence between calibration pattern feature points in camera calibration; and
a processor configured to execute the control program stored in the memory,
wherein the processor is configured to generate calibration pattern candidates from an input image using a point-line-face-multi-face hierarchical structure and to perform verification on the calibration pattern candidates based on a preset verification condition.

7. The apparatus of claim 6, wherein the processor is configured to acquire the input image by capturing a subject while moving around the subject.

8. The apparatus of claim 7, wherein the processor is configured to represent the input image by at least one of a checkerboard, an ellipse, and a concentric circle or a combination thereof and to determine a location of each point by analyzing a characteristic of at least one of the checkerboard, the ellipse, and the concentric circle or a combination thereof.

9. The apparatus of claim 6, wherein the processor is configured to generate each line using a preset number of points.

10. The apparatus of claim 6, wherein the processor is configured to determine each face based on finite sets of lines and determine a maximum number of finite sets of lines when a three-dimensional (3D) structure is configured.
